(19) United States
(12) Patent Application Publication
(10) Pub. No.: US 2012/0261404 A1
(43) Pub. Date: Oct. 18, 2012

(54) HEATING ELEMENT AND MANUFACTURING METHOD THEREOF

(76) Inventors: Hyeon Choi, Daejeon (KR); Su-Jin Kim, Daejeon (KR); Ki-Hwan Kim, Daejeon (KR); Young-Jun Hong, Daejeon (KR)

(21) Appl. No.: 13/515,479

(22) PCT Filed: Dec. 29, 2010
(86) PCT No.: PCT/KR2010/009515

§ 371 Date: Jun. 12, 2012

(30) Foreign Application Priority Data
Dec. 29, 2009 (KR) 10-2009-0132681

(51) Int. Cl. H05B 3/84; H01C 17/06; H01C 17/28; H01C 17/02

(52) U.S. Cl. 219/522; 219/543; 29/613; 29/620; 29/619

(57) ABSTRACT

The present invention provides a heating element, including a transparent substrate, an adhesive agent layer provided on at least one side of the transparent substrate, a conductive heat emitting line provided on the adhesive agent layer, a coating film capsulating the conductive heat emitting line and an upper side of the adhesive agent layer not covered by the heat emitting line, a bus bar electrically connected to the conductive heat emitting line, and a power part connected to the bus bar, and a manufacturing method thereof.

### TECHNICAL FIELD

The present invention relates to a heating element and a manufacturing method thereof. More particularly, the present invention relates to a heating element that includes a pattern that is not well visible, has excellent heat emitting performance at a low voltage, and is capable of minimizing diffraction and interference of light and a coating film formed on the pattern, and a manufacturing method thereof. This application claims priority from Korean Patent Application No. 10-2009-0132681 filed on Dec. 29, 2009 in the KIPO, the disclosure of which is incorporated herein by reference in its entirety.

### BACKGROUND ART

In winter or a rainy day, frost is formed on a glass surface of a vehicle because of a difference between temperatures of the outside and inside of the vehicle. In addition, in the case of an indoor ski resort, a freezing phenomenon occurs because of a difference between temperatures of the inside where there is a slope and the outside of the slope. In order to solve this, a heat emitting glass has been developed. The heat emitting glass uses a concept where after a hot wire sheet is attached to the glass surface or a hot wire is directly formed on the glass surface, a current is applied to both terminals of the hot wire to generate heat from the hot wire, thereby increasing the temperature of the glass surface.

It is important that the heat emitting glass for a vehicle or construction has low resistance in order to smoothly generate heat, but it should not be displeasing to the eye. Accordingly, methods for manufacturing a known transparent heat emitting glass by forming a heat emitting layer through a sputtering process using a transparent conductive material such as ITO (Indium Tin Oxide) or an Ag thin film and connecting an electrode to a front end thereof have been proposed. However, the heat emitting glass according to the above method has a problem in that it is difficult to drive it at a low voltage of 40 V or less because of high surface resistance.

In order to remove frost through an increase in temperature on a glass surface while being driven at a low voltage of 340 V or less, a heating element having a resistance value of 1 ohm/square or less is required, and only one current method for implementing this is to form a metal hot wire. Currently, a method for forming a metal hot wire may be classified into three methods. A first method is a method for forming a metal paste on a transparent substrate by using a printing method and heat sintering the paste. A second method is a method for patterning an etching resistance film on a transparent substrate laminated by using an adhesive layer and etching the film. A third method is a method for forming a silver pattern on a transparent substrate on which a silver salt is coated by using a photograph manner and increasing a pattern thickness until a desired surface resistance is obtained through plating.

In the first and third methods, there is a disadvantage in that there is a difficulty in a process or it takes much time to form the metal pattern having a thickness of 3 μm or more, but in the case of the second method, there is an advantage in that a desired thickness can be obtained by laminating the metal thin film of 10 μm.

In this case, in the second method, the metal thin film is directly laminated on the transparent substrate through the adhesive layer, and a product manufactured by a roll manner is mainly used as the used metal thin film. In the metal thin film, a roll mark is formed in a rolling direction due to a characteristic of a roll process. In the lamination process, the roll mark formed on the metal thin film is transferred on an adhesive layer having elasticity, and the mark transferred in one direction on the adhesive layer remains as it is after the etching process. If the marks arranged in one direction meet a single light source such as headlamps of vehicles, light is scattered in a vertical direction in respects to the arranged marks due to a diffraction/interference phenomenon, such that there is a problem in that it is difficult to apply the marks to products.

The case when additional lamination is performed one more time by using a product including an adhesive layer having a similar refractive index to the above adhesive layer in order to improve turbidity by roughness of the adhesive layer has been proposed, but there is a problem in that the above scattering problem is not improved through this.

### DISCLOSURE

### Technical Problem

The present invention has been made in an effort to provide a heating element including a pattern that is not well visible, can minimize side effects by diffraction and interference in a single light source after sunset and has excellent heat emitting performance at a low voltage and a coating film formed on the pattern, and a manufacturing method thereof.

### Technical Solution

An exemplary embodiment of the present invention provides a heating element, including a transparent substrate, an adhesive agent layer provided on at least one side of the transparent substrate, a conductive heat emitting line provided on the adhesive layer, a coating film capsulating the conductive heat emitting line and an upper side of the adhesive agent layer not covered by the heat emitting line, a bus bar electrically connected to the conductive heat emitting line, and a power part connected to the bus bar.

Another exemplary embodiment of the present invention provides a manufacturing method of a heating element, including laminating a metal thin film on a transparent substrate by using an adhesive agent layer; forming a conductive heat emitting line by etching the metal thin film by using an etching resistance pattern; forming a coating film for capsulating the heat emitting line and an upper side of the adhesive agent layer not covered by the heat emitting line; forming a bus bar electrically connected to the conductive heat emitting line; and forming a power part connected to the bus bar. The etching resistance pattern may be formed by using a photolithography or printing method.

### Advantageous Effects

A heating element according to the present invention can minimize side effects by diffraction and interference of a single light source after sunset, has excellent heat emitting performance at a low voltage, and can be manufactured as a heating element that is not well visible.

### DESCRIPTION OF DRAWINGS

FIG. 1 is a mimetic diagram for measuring surface resistance of a transparent substrate having a pattern.

FIGS. 2 to 3 illustrate forming the pattern by using the Voronoi diagram generator according to an exemplary embodiment of the present invention.

FIGS. 4 to 6 illustrate the pattern of the conductive heat emitting line of the heating element according to an exemplary embodiment of the present invention.

FIG. 7 illustrates forming the pattern by using the Delaunay pattern generator according to an exemplary embodiment of the present invention.

FIGS. 8 to 10 illustrate the pattern of the conductive heat emitting line of the heating element according to an exemplary embodiment of the present invention.

FIG. 11 illustrates the arrangement of the Delaunay pattern generator according to an exemplary embodiment of the present invention.

FIGS. 12 and 13 are vertical cross-sectional views of a heating element according to an exemplary embodiment of the present invention.

FIG. 14 illustrates an equipment configuration for measuring the intensity of light that passes through the heating element according to the present invention.

FIG. 15 illustrates a heat emitting line pattern used in Examples and Comparative Examples.

FIGS. 16 and 17 illustrate pictures of interference patterns by the heating element manufactured in Examples and Comparative Examples.

### BEST MODE

Hereinafter, exemplary embodiments of the present invention will be described in detail.

A heating element according to the present invention includes a transparent substrate, an adhesive agent layer provided on at least one side of the transparent substrate, a conductive heat emitting line provided on the adhesive agent layer, a coating film capsulating the conductive heat emitting line and an upper side of the adhesive agent layer not covered by the heat emitting line, a bus bar electrically connected to the conductive heat emitting line, and a power part connected to the bus bar. The heating element according to the present invention is provided with an adhesive agent layer for attaching the metal thin film for forming the conductive heat emitting line to the transparent substrate on the transparent substrate.

As described in the background art, when the conductive heat emitting line of the heating element is formed by using the transparent substrate in which the metal thin film is laminated by the adhesive agent layer, since the roll mark formed on the metal thin film is transferred on the adhesive agent layer, an indented surface is formed on the adhesive agent layer. Since the indented surface formed on the adhesive agent layer is generated by rotation of the roll, in general, the indented surface is regularly formed. Diffraction and interference patterns of light may be formed by a difference between refractive indexes of the interfaces formed by the regular indented surface. The effect of patterns is maximized by the single light source that is present after sunset such as a headlight of the vehicle or a streetlamp. Therefore, in the case where the heating element that has the indented surface is applied to the front window of the vehicle, the diffraction and interference patterns of light as described above may cause serious safety problems and fatigue for a driver. The diffraction and interference patterns may not be removed by a lamination process using a resin film such as PVB or a lamination process with a film that is provided with another adhesive layer on the board.

In the present invention, a product in which a metal thin film having a thickness of 1 micrometer or more, preferably 3 to 12 micrometers, and more preferably 5 micrometers or more is laminated on the transparent substrate by using the adhesive agent is manufactured. The upper limit of the thickness of the metal thin film may be determined according to the final purpose of the heating element, and is not particularly limited thereto.

As the material of the metal thin film, it is preferable that copper or aluminum is used, but it is not limited thereto. As the adhesive agent layer, an adhesive film may be used or a product in which an adhesive component is coated on a board may be used.

In the present invention, the transparent substrate is not particularly limited, but it is preferable to use the board where the light permeability is 50% or more, and preferably 75% or more. In detail, glass may be used as the transparent substrate, and the plastic board or plastic film may be used. In the case where the plastic film is used, it is preferable that after the conductive heat emitting line pattern is formed, glass is attached on at least one side of the board. In this case, it is more preferable that the glass or plastic substrate is attached to the side on which the conductive heat emitting line pattern of the transparent substrate is formed. A material that is known in the art may be used as the plastic substrate or film, and for example, it is preferable to use the film that has the visible ray permeability of 80% or more such as PET (Polyethylene terephthalate), PVB (polyvinylbutyral), PEN (polyethylene naphthalate), PES (polyethersulfon), PC (polycarbonate), and acetyl celluloid. The thickness of the plastic film is preferably 12.5 to 500 micrometers, and more preferably, 30 to 150 micrometers.

A printing method and a photolithography method may be used in order to form the etching resistance pattern on the transparent substrate on which the metal thin film is laminated by the adhesive agent layer. As the printing method, a reverse offset printing method or a gravure offset method which can print a line having a width of 5 to 100 μm may be used. The etching resistance layer may use novolac-based, acryl-based, and silicon-based materials, but is not limited thereto. When the photolithography is used, the etching resistance pattern may be formed by using a photoresist material, and in particular, a dry film resist may be used in order to apply it to a roll process.

The etching resistance pattern is advantageously irregular in order to minimize diffraction/interference by the single light source, but it is preferable that the pattern has a pattern density having a permeability deviation of 5% or less in respects to an arbitrary circle that has a diameter of 20 cm. In addition, in the case of the regular pattern such as a wave pattern, it is preferable that an interval between the lines forming the pattern is 2 mm or more.

A process for forming the conductive heat emitting line by etching the metal thin film may be performed by using an etching method known in the art. For example, the metal thin film is etched by dipping the transparent substrate including the metal thin film that is provided with the etching resistance pattern into the etching solution. An acidic solution may be used as the etching solution. As the acidic solution, a strong acid such as a hydrochloric acid, a nitric acid, a sulfuric acid, and a phosphoric acid, and an organic acid such as a formic acid, a butyric acid, a lactic acid, a sorbic acid, a fumaric acid, a malic acid, a tartaric acid, and a citric acid may be used, and hydrogen peroxide and other additives may be further added to the solution.

In the present invention, the line width of the conductive heat emitting line is 100 micrometers or less, preferably 70 micrometers or less, more preferably 50 micrometers or less, and much more preferably 30 micrometers or less. In particular, in the case where the line width is 30 micrometers or less, and preferably 0.1 to 30 micrometers, the conductive heat emitting pattern is not shown by the eye, such that it is advantageous to ensure the view field.

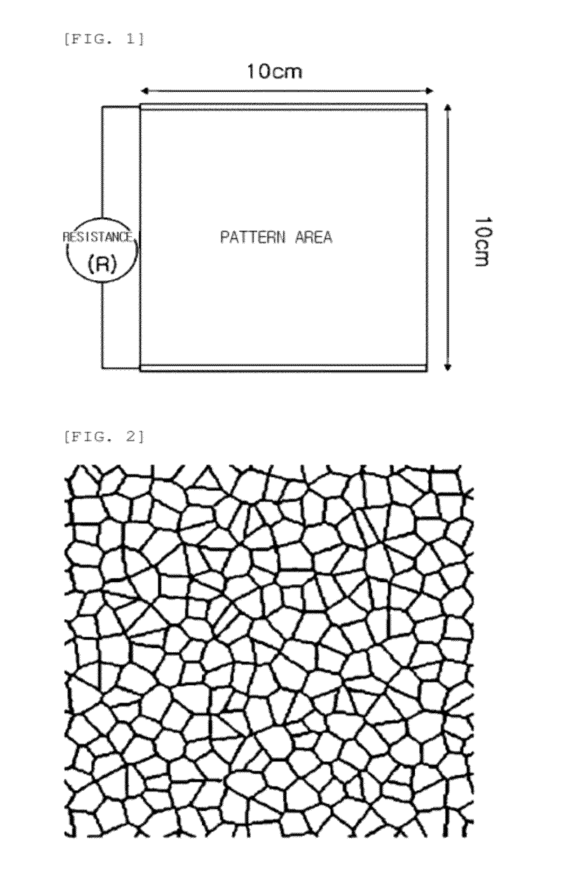

After the board that is provided with the metal heat emitting line obtained through the above process is cut in a size of 10 cm×10 cm, as shown in FIG. 1, when the resistance is measured by forming an electrode line on one side thereof, it is preferable that it has 1 ohm or less, and preferably 0.5 ohm. In this case, the obtained resistance value has the same meaning as the surface resistance.

For the uniform heat emitting and visibility of the heating element, it is preferable that the opening ratio of the pattern is constant in the unit area. It is preferable that the permeability deviation of the heating element is 5% or less in respects to an arbitrary circle that has the diameter of 20 cm. In this case, the heating element may prevent the local heat emission. In addition, in the heating element, it is preferable that after the heat emission, the standard deviation of the surface temperature of the transparent substrate is within 20%.

In the present invention, the heat emitting line may be formed of the straight lines, or various modifications such as curved lines, wave lines, and zigzag lines may be feasible.

FIG. 2 illustrates a pattern of a conductive heat emitting line according to an exemplary embodiment of the present invention. The area distribution ratio of the pattern is 20% or more, for example, 20% to 35%.

According to the exemplary embodiment of the present invention, the conductive heat emitting line pattern may be a boundary shape of the figures that form a Voronoi diagram.

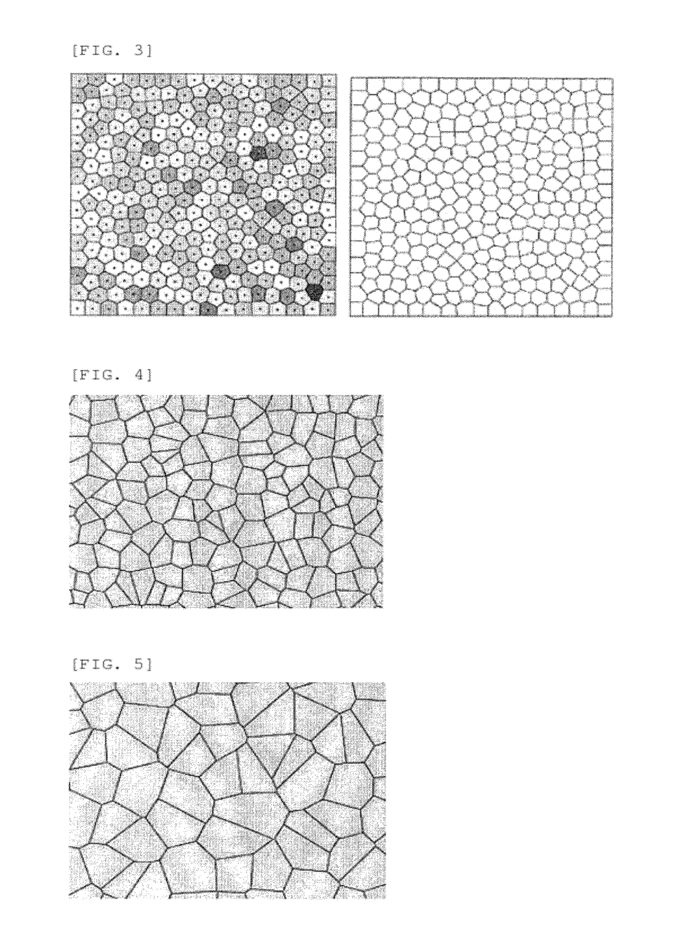

In the present invention, side effects by diffraction and interference of light can be minimized by forming the conductive heat emitting line in a boundary form of figures that configure the Voronoi diagram. The Voronoi diagram is a pattern that is formed by filling the closest area to the corresponding dot as compared to the distance of each dot from the other dots if Voronoi diagram generator dots are disposed in a desired area to be filled. For example, when large discount stores in the whole country are represented by dots and consumers find the closest large discount store, the pattern that displays the commercial area of each discount store may be exemplified. That is, if the space is filled with regular hexagon and each dot of the regular hexagon is set by the Voronoi generator, the conductive heat emitting line pattern may be a honeycomb structure. In the present invention, in the case where the conductive heat emitting line pattern is formed by using the Voronoi diagram generator, there is an advantage in that the complex pattern form that can minimize the side effects by the diffraction and interference of light can be easily determined. FIG. 3 illustrates the forming of the pattern using the Voronoi diagram generator. An example of the other conductive heat emitting line pattern is illustrated in FIGS. 4 to 6, but the scope of the present invention is not limited thereto.

In the present invention, the pattern that is obtained from the generator may be used by regularly or irregularly positioning the Voronoi diagram generator.

Even in the case where the conductive heat emitting line pattern is formed in a boundary form of the figures that form the Voronoi diagram, as described above, in order to solve the visual recognition problem, when the Voronoi diagram generator is generated, the regularity and irregularity may be appropriately harmonized. For example, after the area having a predetermined size is set as the basic unit in the area in which the pattern is provided, the dots are generated so that the distribution of dots in the basic unit has the irregularity, thus manufacturing the Voronoi pattern. If the above method is used, the visibility can be compensated by preventing the localization of the distribution of lines on the one point.

As described above, in the case where the opening ratio of the pattern is made constant in the unit area for the uniform heat emission and visibility of the heating element, it is possible to control the number per unit area of the Voronoi diagram generator. In this case, when the number per unit area of the Voronoi diagram generator is uniformly controlled, it is preferable that the unit area is 10 cm² or less. The number per unit area of the Voronoi diagram generator is preferably 10 to 2,500/cm² and more preferably 10 to 2,000/cm².

Among the figures that form the pattern in the unit area, at least one has preferably the different shape from the remaining figures.

According to another exemplary embodiment of the present invention, the conductive heat emitting line pattern may be a boundary form of the figures that are formed of at least one triangle forming the Delaunay pattern. In detail, the form of the conductive heat emitting line pattern is a boundary form of the triangles that form the Delaunay pattern, a boundary form of the figures formed of at least two triangles that form the Delaunay pattern or a combination thereof.

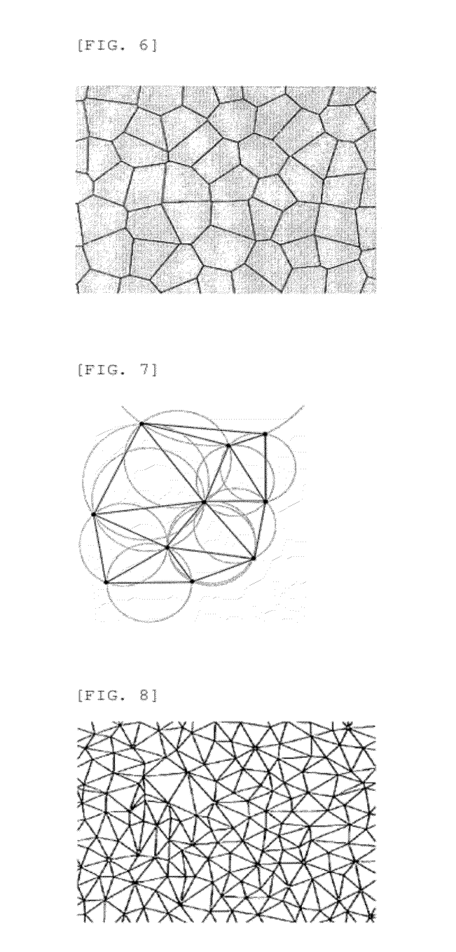

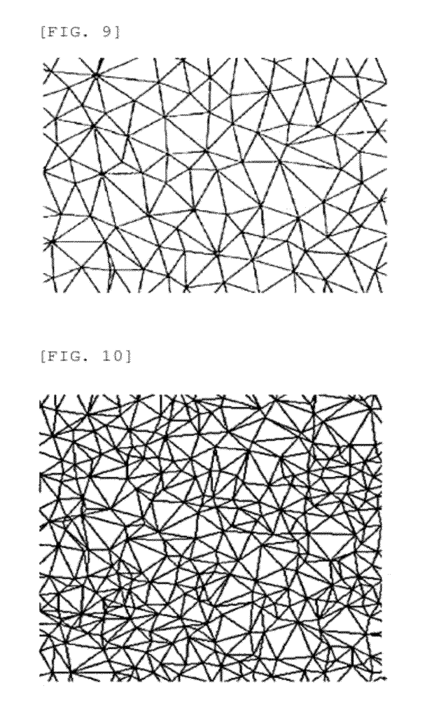

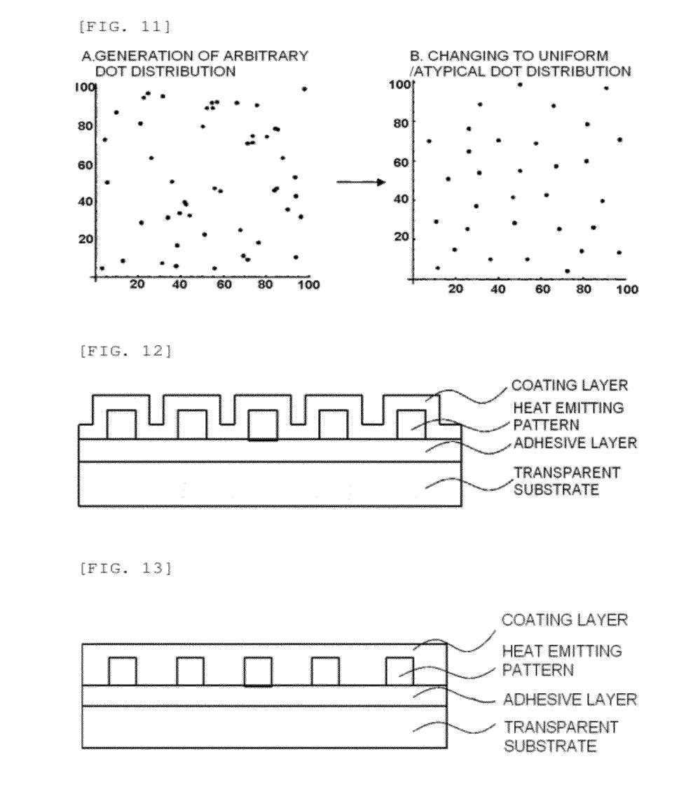

The side effects by diffraction and interference of light may be minimized by forming the conductive heat emitting line pattern in the boundary form of the figures that are formed of at least one triangle that forms the Delaunay pattern. The Delaunay pattern is a pattern that is formed by disposing the Delaunay pattern generator dots in the area in which the pattern will be filled and drawing a triangle by connecting three dots therearound so that when the circumcircle that includes all corners of the triangle is drawn, there is no other dot in the circle. In order to form the pattern, Delaunay triangulation and circulation may be repeated on the basis of the Delaunay pattern generator. The Delaunay triangulation may be performed in such a way that a thin triangle is avoided by maximizing the minimum angle of all angles of the triangle. The concept of the Delaunay pattern was proposed by Boris Delaunay in 1934. An example of formation of the Delaunay pattern is shown in FIG. 7. In addition, an example of the Delaunay pattern is shown in FIG. 8 to FIG. 10. However, the scope of the present invention is not limited thereto.

The pattern of the boundary form of the figures that are formed of at least one triangle that forms the Delaunay pattern may use the pattern that is obtained from the generator by regularly or irregularly positioning the Delaunay pattern generator. In the exemplary embodiment of the present invention, in the case where the conductive heat emitting line pattern is formed by using the Delaunay pattern generator, there is an advantage in that the complex pattern form that can minimize the side effects by the diffraction and interference of light can be easily determined.

Even in the case where the conductive heat emitting line pattern is formed in a boundary form of the figures that are formed of at least one triangle that forms the Delaunay pattern, in order to solve the visual recognition problem as described above, when the Delaunay pattern generator is generated, the regularity and irregularity may be appropriately harmonized. For example, an irregular and uniform standard dot is generated in the area in which the pattern is provided. In this case, the irregularity means that the distances between the dots are not constant, and the uniformity means that the numbers of the dots that are included per unit area are the same as each other.

An example of the method for generating the irregular and uniform standard dots will be exemplified below. As shown in FIG. 11A, an arbitrary dot is generated on the entire surface. After that, the interval between the generated dots is measured, and in the case where the interval between the dots is smaller than the value that is previously set, the dots are removed. In addition, the Delaunay triangle pattern is formed on the basis of the dots, and in the case where the area of the triangle is larger than the value that is previously set, the dots are added in the triangle. If the above process is performed repeatedly, as shown in FIG. 11B, the irregular and uniform standard dots are generated. Next, the Delaunay triangle that includes one generated standard dot is generated. In this step, it may be performed by using the Delaunay pattern. If the above method is used, the visibility can be compensated by preventing the localization of the distribution of lines on the one point.

As described above, in the case where the opening ratio of the pattern is made constant in the unit area for the uniform heat emission and visibility of the heating element, it is preferable to control the number per unit area of the Delaunay pattern generator. In this case, when the number per unit area of the Delaunay pattern generator is uniformly controlled, it is preferable that the unit area is 10 cm² or less. The number per unit area of the Delaunay pattern generator is preferably 10 to 2,500/cm² and more preferably 10 to 2,000/cm².

Among the figures that form the pattern in the unit area, at least one has preferably the different shape from the remaining figures.

In the present invention, since the aforementioned heat emitting line pattern is formed on the transparent substrate by using the method described below, the line width and line height may be made uniform. According to the exemplary embodiment of the present invention, at least a portion of the conductive heat emitting line pattern may be formed differently from the remaining pattern. The desired heat emitting line pattern may be obtained by this configuration. For example, in the vehicle glass, in order to ensure the view field first in the area which is positioned in front of the driver, the heat emitting line patterns of the corresponding area and the remaining area may be different from each other. The line widths and line intervals of the printing pattern may be different from each other so that at least a portion of the heat emitting line pattern is different from the remaining printing pattern. Therefore, the heat emission may more rapidly or efficiently occur at a desired place.

According to the exemplary embodiment of the present invention, the heating element may include an area in which the conductive heat emitting line is not formed. Transmission and reception of a predetermined frequency can be performed by allowing at least a portion of the heating element not to form the conductive heat emitting line, and information transmission and reception may be performed between the internal space and the external space. In this case, the area in which the conductive heat emitting line is not formed may have an area that varies according to the desired frequency of the transmission and reception. For example, in order to pass through the electromagnetic wave of 1.6 GHz that is used in the GPS, the area that has the long side that is ½ (9.4 cm) or more of the above wavelength is required. The area in which the conductive heat emitting line is not formed may have an area that can transmit and receive the desired frequency, and its form is not particularly limited. For example, in the present invention, in order to pass through the electromagnetic wave, the area in which the conductive heat emitting line is not formed may provide the heating element that is provided with one or more semicircular areas that have the diameter of 5 to 20 cm.

According to the exemplary embodiment of the present invention, the conductive heat emitting line may be blackened.

In order to maximize the minimization effect of side effects by the diffraction and interference of light, the conductive heat emitting line pattern may be formed so that the area of the pattern that is formed of the figures having the asymmetric structure is larger than the entire pattern area by 10% or more. In addition, it may be formed so that the area of the figures in which at least one of the lines that connect the central point of any one figure that forms the Voronoi diagram and the central point of the adjacent figure forming the boundary in conjunction with the figure is different from the remaining lines in view of length is larger than the entire conductive heat emitting line pattern area by 10% or more. In addition, it may be formed so that the area of the pattern formed of the figures where the length of at least one side that configures the figure that is formed of at least one triangle forming the Delaunay pattern is different from the length of the other sides is 10% or more in respects to the area where the pattern of the entire conductive heat emitting line is formed.

When the heat emitting line pattern is manufactured, after the pattern is designed in a limited area, the method in which the limited area is repeatedly connected is used to manufacture a large area pattern. In order to repeatedly connect the patterns, the repetitive patterns may be connected to each other by fixing the positions of the dots of each quadrilateral. In this case, the limited area has the area of preferably 10 cm² or more and more preferably 100 cm² or more in order to minimize the diffraction and interference by the repetition.

It may be formed so that the aforementioned line width of the conductive heat emitting line is 100 micrometers or less, preferably 30 micrometers or less, and more preferably 25 micrometers or less.

A coating film is formed on the metal pattern. In this case, the coating film should be able to fill an indented surface of the adhesive agent layer formed on the upper area of the board not covered by the conductive heat emitting line in the board that is provided with the conductive heat emitting line. In this case, it is preferable that a difference between refractive indexes of the coating film and the adhesive agent layer is 1 or less. Since the indented surface of the adhesive agent layer mainly has roughness of 1 micrometer or less, it is preferable that the thickness of the coating film is 1 micrometer or more. The coating film, as shown in FIG. 12, may be coated in a thickness of the conductive heat emitting line or less, or may be coated in a thickness of the conductive heat emitting line or more, thus obtaining a flat surface.

It is preferable that the composition for forming the coating film has 60% or less of solids and a viscosity of 50 cps or less. If the viscosity is more than 50 cps, it is not easy to planarize the adhesive layer. The lower limit of the viscosity of the composition for forming the coating film may be controlled according to the degree of thickness and planarization of the desired coating film, and it is preferable that the composition has the viscosity of 0.5 cps or more.

In addition, it is preferable that the surface roughness of the coating film after the planarization has a height deviation of 100 mm or less at an upper area of the adhesive agent layer not covered by the conductive heat emitting line. The height of the coating film may be measured from the upper side or the lower side of the transparent substrate.

The composition for forming the coating film is not limited if the composition satisfies the above condition, but it is preferable that the composition includes acrylate and urethane-based components.

In the present invention, even when the metal thin film is used in order to form the conductive heat emitting line as described above, since diffraction and interference of light by marks generated in the adhesive agent layer during the lamination of the metal thin film by the above coating film may be compensated, it is possible to provide the heating element having excellent optical properties. In detail, when light emitted from a light source that is 7 m apart from the heating element passes through the heating element, it is possible to provide the heating element, from which an interference pattern that is generated in a circumference direction of the light source at an angle that is rectangular to the roll mark of the adhesive layer is removed. By this physical property, it is possible to prevent side effects by the diffraction and interference of the single light source that can be detected by the naked eye in a dark area.

Since there may be present a deviation according to the kind of light source, in the present invention, as the standard light source, an incandescent lamp of 100 W is used. The intensity of light is measured through a digital camera. The photographing condition of the camera is set so that, for example, F (aperture value) is 3.5, a shutter speed is 1/100, ISO is 400 and a black and white image is ensured. After the image is obtained by using the camera as described above, the intensity of light may be rated through an image analysis.

In the present invention, when the intensity of light is measured, the light source is disposed at the center in the black box that has the width of 30 cm, length of 15 cm, and the height of 30 cm, and the equipment where the circle that has the diameter of 12.7 mm is opened before the point of 7.5 cm from the center of the light source is used. The light source of the double phase measurement equipment device according to KS L 2007 standard is adopted. The digital image that is obtained by using the above condition is stored in 1600×1200 pixels, the intensity of light per each pixel is represented by the numerical value in the range of 0 to 255, and the area in the light source area per each pixel has the value in the range of 0.1 to 0.16 mm².

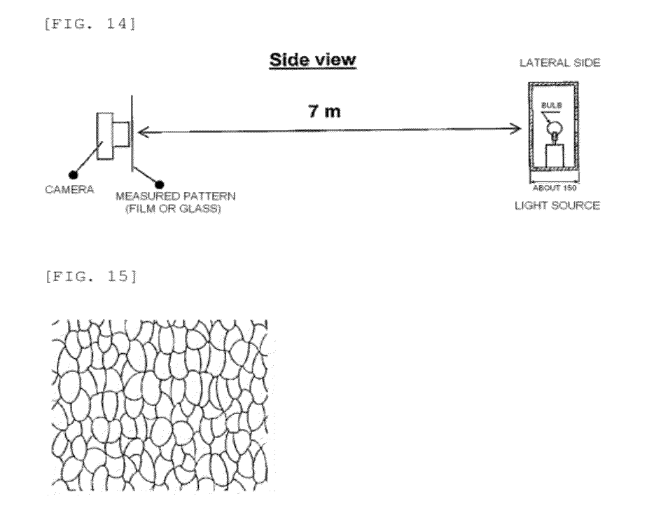

It is preferable that the measurement of the intensity of light is performed in the dark room. FIG. 14 illustrates the configuration of the equipment.

The image of light passing through the heating element obtained in the above manner may display the black color in the pixel having the intensity of light of 10 or less, the white color in the pixel having the intensity of light of 25 or more, and the gray scale color in the pixel having the intensity of light of 10 to 25. As shown in FIG. 17, in the product that may be obtained from the related art (Comparative Examples 1 and 2), the image obtained in the above manner forms a straight white line between white patterns having the dumbbell shape. However, according to the present invention, the interference pattern having the dumbbell shape or the straight line shape is not present. The case where the interference pattern having the dumbbell shape or the straight line shape is not present is defined by the case where the interference pattern is not substantially present. In other words, in the present invention, when light emitted from a light source that is 7 m apart from the heating element passes through the heating element, the fact that the interference pattern is not substantially generated in a circumference direction of the light source means that the dumbbell shape or the straight line shape is not present in a circumference direction of the image of light having the intensity of 25 or more in light passing through the heating element.

In the method for manufacturing the heating element according to the exemplary embodiment of the present invention, the step for forming the bus bar that is electrically connected to the conductive heat emitting line and the step for providing the power part that is connected to the bus bar are performed. These steps may use a method that is known in the art. For example, the bus bar may be simultaneously formed in conjunction with the formation of the conductive heat emitting line, and may be formed by using the same or different method after the conductive heat emitting line is formed. For example, after the conductive heat emitting line is formed, the bus bar may be formed through the screen printing. In this case, the thickness of the bus bar is appropriately 1 to 100 micrometers and preferably 10 to 50 micrometers. If it is less than 1 micrometer, since the contact resistance between the conductive heat emitting line and the bus bar is increased, local heat emission may be generated at the contact portion, and if it is more than 100 micrometers, the cost of the electrode material is increased. The connection between the bus bar and power may be performed through soldering and physical contact to the structure that has good conductive heat emission.

In order to conceal the conductive heat emitting line and the bus bar, the black pattern may be formed. The black pattern may be printed by using the paste that includes cobalt oxides. In this case, it is appropriate that the printing method is the screen printing and its thickness is 10 to 100 micrometers. The conductive heat emitting line and the bus bar may be formed before or after the black pattern is formed, respectively.

The heating element according to the present invention may include an additional transparent substrate that is provided on a side on which the conductive heat emitting line of the transparent substrate is provided. When the additional transparent substrate is attached, an adhesive film may be provided between the conductive heat emitting line and additional transparent substrate. In the attaching process, the temperature and pressure may be controlled.

In one detailed embodiment, the adhesive film is inserted between the transparent substrate on which the conductive heat emitting pattern is formed and additional transparent substrate, and they are put into the vacuum bag, and reduced in pressure or increased in temperature or increased in temperature by using the hot roll, thus removing the air, thereby accomplishing the first attachment. In this case, the pressure, temperature and time may vary according to the kind of the adhesive film, but in general, the temperature may be gradually increased from normal temperature to 100° C. at a pressure of 300 to 700 Torr. In this case, it is preferable that the time is generally 1 hour or less. The preliminarily attached layered structure that is first attached is subjected to a second attachment process by the autoclaving process where the temperature is increased while the pressure is added in the autoclave. The second attachment varies according to the kind of the adhesive film, but it is preferable that after the attachment is performed at the pressure of 140 bar or more and the temperature in the range of 130 to 150° C. for 1 to 3 hours, and preferably about 2 hours, it is slowly cooled.

In the other detailed embodiment, the method for attaching them through one step by using the vacuum laminator device unlike the above two-step attachment process may be used. The attachment may be performed by stepwisely increasing the temperature to 80 to 150° C. and slowly cooling them so that the pressure is reduced (to 5 mbar) until the temperature is 100° C. and thereafter the pressure is added (to 1000 mbar).

Any material that has an adhesive strength and is transparent after attaching may be used as the material of the adhesive film. For example, the PVB film, EVA film, PU film and the like may be used, but the adhesive film is not limited thereto. The adhesive film is not particularly limited, but it is preferable that its thickness is in the range of 100 micrometers to 800 micrometers.

In the above method, the additional transparent substrate to be attached may be formed of only the transparent substrate and may be the transparent substrate that is provided with the conductive heat emitting line that is manufactured as described above.

The heating element according to the present invention may be connected to the power for heat emission, and in this case, the heat emitting amount is 100 to 700 W per m², and preferably 200 to 300 W. Since the heating element according to the present invention has excellent heat emitting performance even at the low voltage, for example, 30 V or less, and preferably 20 V or less, it may be usefully used in vehicles and the like. Resistance in the heating element is 1 ohm/square or less, and preferably 0.5 ohm/square or less.

The heating element according to the present invention may have a shape of curved surface.

In the heating element according to the present invention, it is preferable that the opening ratio of the conductive heat emitting line pattern, that is, the area ratio of the transparent substrate that is not covered by the pattern is 70% or more. The heating element according to the present invention has an excellent heat emitting property where an opening ratio is 70% or more, the temperature deviation within 5 min after heat emission operation is maintained at 10% or less, and the temperature is increased.

The heating element according to the present invention may be applied to glass that is used for various transport means such as vehicles, ships, railroads, high-speed railroads, and airplanes, houses or other buildings. In particular, since the heating element according to the present invention has an excellent heat emitting property at a low voltage, can minimize side effects by diffraction and interference of single light source after sunset, and can be invisibly formed in the above line width, unlike the known technology, it may be also applied to the front window for the transport means such as vehicles.

### [Mode for Invention]

Hereinafter, preferred Examples will be described in order to help understanding of the present invention. However, the following Examples are set forth to illustrate the present invention, but the scope of the present invention is not limited thereto.

### Example 1

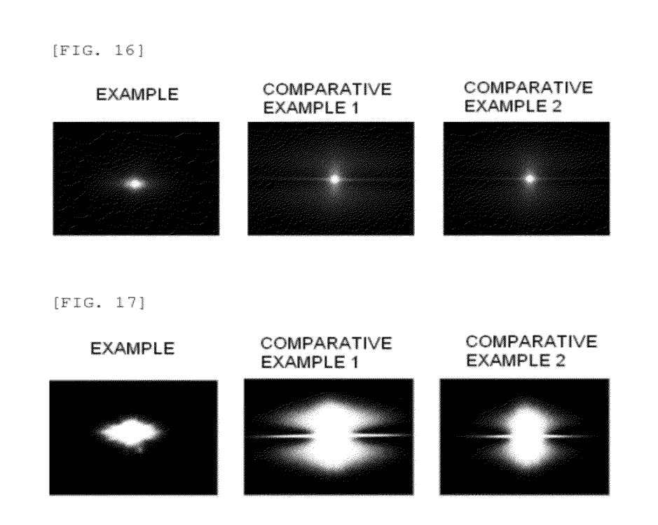

The copper foil having the thickness of 10 micrometers was laminated on the PET film having the thickness of 125 micrometers. After the novolac-based dry film resist was laminated on the copper foil of the board, the etching resistance pattern having the line width of 10 to 15 micrometers was formed by using the photolithography process. The heat emitting line was formed by dipping the PET film including the copper foil that was provided with the etching resistance pattern in the copper etching solution. In this case, the aqueous solution including 20% hydrogen peroxide was used as the etching solution. The etching resistance pattern, as shown in FIG. 15, was formed by generating irregular dots in the basic unit of 2 mm×4 mm, forming the Voronoi pattern, and using the curved line as the line.

When the bus line was formed on the board that was provided with the copper heat emitting line, as shown in FIG. 1, and the resistance was measured, the measured resistance was 0.38 ohms.

The coating solution including DPHA (dipentaerythritol hexaacrylate) and the photocuring agent and having 51% solids was bar coated on the board that was provided with the heat emitting line. In this case, the viscosity of the formed coating solution was 5 cps, and the film having the coating thickness of 4 micrometers, permeability of visible rays of 92%, and the haze of 1.1% was obtained.

The laminated glass obtained by laminating the film while the film was disposed between PVBs having the thickness of 760 micrometers had the permeability of 89% and the haze of 1.2%.

### Comparative Example 1

The same film and laminated glass as Example 1 were manufactured, except that the PET film having the thickness of 125 micrometers and including the acrylate-based adhesive agent was laminated on the pattern instead of forming the coating film.

### Comparative Example 2

After the film was manufactured in the same manner as Example 1 without forming the coating film, the laminated glass was manufactured.

As described in the present invention, the scattered light was measured in the area having no pattern by using the device of FIG. 14. In this case, as the used product, the laminated glasses manufactured in Example 1, Comparative Example 1 and Comparative Example 2 were used. As a result, as shown in FIG. 16, it can be seen that the scattering pattern of light by the roll mark of the adhesive layer is removed in only Example 1.

In FIG. 17, the image of light passing through the laminated glass manufactured in Example 1, Comparative Example 1 and Comparative Example 2 displayed the black color in the pixel having the intensity of light of 10 or less, the white color in the pixel having the intensity of light of 25 or more, and the gray scale color in the pixel having the intensity of light of 10 to 25. As shown in FIG. 17, in Comparative Examples 1 and 2, the image of light passing through the laminated glass formed the straight white line between white patterns having the dumbbell shape, but in Example 1, the interference pattern having the dumbbell shape or the straight line shape was not present.

1. A heating element, comprising:
a transparent substrate,
an adhesive agent layer provided on at least one side of the transparent substrate,
a conductive heat emitting line provided on the adhesive agent layer,
a coating film capsulating the conductive heat emitting line and an upper side of the adhesive agent layer not covered by the heat emitting line,
a bus bar electrically connected to the conductive heat emitting line, and a power part connected to the bus bar.

2. The heating element according to claim 1, wherein the adhesive agent layer laminates a metal thin film for forming the conductive heat emitting line on the transparent substrate.

3. The heating element according to claim 1, wherein a thickness of the conductive heat emitting line is 5 micrometers or more.

4. The heating element according to claim 1, wherein the conductive heat emitting line is provided so as to have a permeability deviation of 5% or less in respects to an arbitrary circle that has a diameter of 20 cm.

5. The heating element according to claim 1, wherein an opening ratio of the transparent substrate is 70% or more.

6. The heating element according to claim 1, wherein the conductive heat emitting line is provided in a pattern shape of a boundary shape of figures forming a Voronoi diagram or a boundary shape of figures formed of at least one triangle forming a Delaunay pattern.

7. The heating element according to claim 1, wherein a line width of the conductive heat emitting line is 100 micrometers or less.

8. The heating element according to claim 1, wherein a thickness of the coating film is 1 micrometer or more.

9. The heating element according to claim 1, wherein the coating film is formed by using a composition having a viscosity of 50 cps or less.

10. The heating element according to claim 1, wherein a height deviation of the coating film provided on an upper area of the transparent substrate not covered by the conductive heat emitting line is 100 nm or less.

11. The heating element according to claim 1, wherein when light emitted from a light source that is 7 m apart from the heating element passes through the heating element, an interference pattern is not substantially generated in a circumference direction of the light source.

12. The heating element according to claim 1, further comprising a transparent substrate that is provided on a side on which the coating film is provided.

13. A manufacturing method of a heating element, comprising:
laminating a metal thin film on a transparent substrate by using an adhesive agent layer;
forming a conductive heat emitting line by etching a metal thin film by using an etching resistance pattern;
forming a coating film for capsulating the heat emitting line and an upper side of the adhesive agent layer not covered by the heat emitting line;
forming a bus bar electrically connected to the conductive heat emitting line; and
forming a power part connected to the bus bar.

14. The manufacturing method of a heating element according to claim 13, wherein the coating film is formed by using a composition having a viscosity of 50 cps or less.
